(19) United States
(12) Patent Application Publication
(10) Pub. No.: US 2012/0191473 A1
(43) Pub. Date: Jul. 26, 2012

(54) PORTABLE MEDICAL DEVICE FOR RECORDING AND COMMUNICATING FULL MEDICAL HISTORY

(76) Inventor: Darlene Severin, Champaign, IL (US)

(21) Appl. No.: 13/012,112

(22) Filed: Jan. 24, 2011

(51) Int. Cl. G06Q 50/00; G06Q 10/00

(52) U.S. Cl. 705/3; 705/2

(57) ABSTRACT

A portable, hand held or body worn device for storing and presenting personal medical information, so as to establish a comprehensive medical history which can be consulted by medical care providers. The device may comprise a data processing device which can receive, store, organize, and display or transmit medical data, and may comprise any or a combination of a cellular telephone, an internet capable device, or a dedicated medical assistance summoning device. Data entered into memory may be secured against unauthorized access. Stored data may pertain in addition to specific person medical history, peripheral medical topics such as pre-established power of attorney, living will arrangements, medical donor information, and emergency contact information. The device may obtain non-patient specific medical information such as updated pharmaceutical advisories. The invention may be a software application for implementing a personal medical database in a personal portable electronic device such as a smart phone, tablet, or the like.

### FIELD OF THE INVENTION

The present invention relates to digital data storage and presentation, and more particularly to a portable device in possession of and used by individual patients for storing and presenting medical data pertaining to that one individual or optionally, additional individuals.

### BACKGROUND OF THE INVENTION

When a person or person is in need of medical care from a medical care provider, there arises a significant burden imposed on the care provider to be aware of all pertinent medical history and other conditions surrounding the patient. Apart from information which may be relatively quickly and easily obtained from the patient, such as body temperature, blood pressure, heart rate, and other readily discerned aspects, there is usually a need to know the patient's medical history, ongoing conditions, what medications are currently prescribed or being taken, and others.

It is frequent practice to have a patient fill out a paper form listing pertinent queries to supply this information to the care provider. However, this procedure is largely dependent on the memory of the patient, availability of paper records which can supplement the patient's memory, and other sources. Any or all of the patient's memory, paper records, and other sources may be incomplete, inaccurate, obsolescent, or a combination of these. Even if these sources are complete, correct, and up to date, it may take a considerable amount of time to fill out the paper form, possibly requiring assistance on the part of office personnel. It may possibly also be necessary to communicate with others in the medical field, such as remotely located care givers who have provided limited services, in order to arrive at a complete record. Therefore, reliability of the available history and time efficiency of its compilation potentially and frequently in practice degrade effectiveness and efficiency of ensuing medical care.

There exists a need in the prior art for a way of compiling complete, correct, up to date medical records in a format which facilitates ready reference by medical personnel, and offers the possibility of ready communication to databases, remote facilities, and the like.

More notably, there exists a need for a system which is patient focused, in that an ordinary person not familiar with medical field terminology can readily and easily compile medical records, particularly using ordinary apparatus, such as so-called smart phones, which apparatus is not dedicated medical apparatus. The need further includes single point data entry, ability to accommodate use by non-medical people, and avoidance of reliance on medical jargon.

### SUMMARY OF THE INVENTION

The present invention provides a system which provides a reasonably user friendly, effective way of compiling complete, correct, up to date medical records in a way which is easily used by both patients and medical personnel, and is capable of readily accepting new or different data. The novel system is easily hand held or body worn or both, and is easily portable.

The system utilizes a data processing device small enough to be hand held, such as a cellular telephone, a personal digital assistant, dedicated portable device for summoning assistance, or the like, and suitable programming The device includes memory, a data processor, a data entry interface, an output which ultimately comprises or drives a visual display, and optionally, communications capabilities enabling receipt and transfer of data.

Therefore, an entire medical history and related information is made available, viewable, portable, and easily transmitted to others. The system relieves both patient and medical personnel from reliance on memory, cumbersome transcription from paper records or the like, and other tedious retrieval, correction, or verification of the medical record.

Unlike many medical data systems, which have been developed with the intention that they are to be used more or less exclusively by medical personnel, the present invention contemplates a system that is oriented for use by non-medical personnel, more notably, by people maintaining their own medical database. To this end, the system may be implemented on general purpose devices such as smart phones, and may take the form of applications which may be loaded into and operated by general purpose devices.

A system is thus established which is patient focused and patient friendly in use. The system, whether regarded as apparatus and software application combined, or alternatively as only software applications, is immediately accessible, may provide links to medical updates, provides a personal calendar or other date and time based scheduling protocol, and may incorporate programs and scheduling which are personalized for the individual, such as medication, health maintenance, and the like. Chronological histories of medication implementation, biological cycles, and other time lines personal to the patient may be stored readily at hand.

It is a significant advantage of the invention that control of the history, ability to change or update stored data, and summarizations of medication dosages and purposes be transferred to the individual, such that the individual is encourage to take control of his or her medical life, rather than to be reliant upon a remote medical practice or establishment for this.

Doctors' offices, hospitals, and other medical facilities will benefit from improved efficiency both when processing administrative tasks relating to processing a patient, and also at the time of administering actual medical services. This can be done without reliance upon unreliable sources of medical information such as the memory of a person who may have reduced memory capabilities, may be feeling the effects of a stressful situation, or is otherwise impaired.

It is an object of the invention to provide a portable, easily used single device for compiling, transporting, and displaying a full and accurate medical history of one or more people.

It is a further object of the invention to transfer control of one's own medical situation to the patient rather than depositing control with a medical establishment.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a plan view of the apparatus of a portable medical device according to at least one aspect of the invention.

FIG. 2 is a diagrammatic representation of powered electrical or electronic components of a portable medical device according to at least one aspect of the invention.

### DETAILED DESCRIPTION

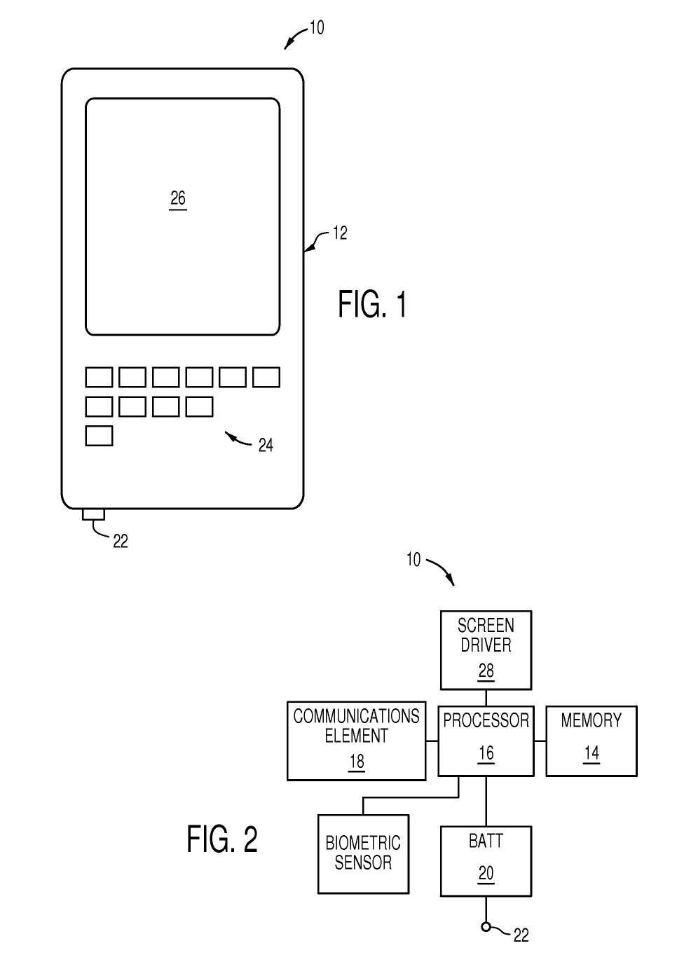

Referring to FIGS. 1 and 2, according to at least one aspect of the invention, there is shown a portable device 10 for compiling, storing, transmitting, and displaying medical data. The apparatus of the portable device 10 may comprise a housing 12 of hand held dimensions and configuration, which will be understood to signify that the housing 12 is graspable in one hand, worn on the body at least at times, or is otherwise kept in close proximity to the user's body with minimal effort by the user. Contained within the housing 12 are data processing apparatus further comprising a memory device 14 and a data processor 16 which is disposed in communication with the memory device 14. Preferably although optionally, a communications element 18 is contained within the housing 12, which communications element 18 is disposed in communication with the data processor 16 and is preferably capable of transmitting entered data wirelessly, and, further preferably but optionally, of receiving data wirelessly for entry into the memory device 14.

A battery 20 may be provided within the housing 12, and will be understood to be operably connected to electrically powered components of the portable device 10. The battery 20 may comprise a single electrochemical cell, plural electrochemical cells, any type of capacitor including supercapacitors, double layer capactitors, and the like, and any combination of these. The battery 20 may be recharged using an exposed power port 22.

Disposed on the exterior of the housing 12 may be an operating element such as keys 24 and a display screen 26. It should be noted that the display screen 26 may be a touchscreen incorporating ability to receive manual control commands, and may be utilized in place of separate keys 24, thereby combining the functions of the display screen 26 and the operating element in one component.

It will be understood that the portable device 10 will be provided with all necessary electrical and data conductors, switches, controls, and other known apparatus to enable the components described herein to communicate among one another and to perform as described. Illustratively, the portable device 10 will be understood to include a screen driver 28 capable of generating desired image contact on the screen 26.

The portable device 10 may comprise or take on characteristics of known data processing and communications devices such as cellular telephones, personal digital assistants, medical assistance summoning devices (none shown), for example. The portable device 10 may have abilities to conduct general purpose communications over generally available communications channels such as cellular telephone networks, the internet, and others. Illustratively, the portable device 10 may be incorporated into an existing commercial product (not shown) such as an iPod® or a Blackberry® product, among others.

In another implementation of the invention, the portable device 10 may be incorporated into a dedicated medical service apparatus (not shown) such as a communicator for summoning assistance, either by manual action such as depressing a pushbutton or by automatic function, an example being that playing a role in the Lifeline Medical Alert Service offered by Royal Philips Electronics of the Netherlands. Such a dedicated medical device may lack ability to conduct general purpose communications over generally available communications channels, so that it may be regarded as specific purpose.

The portable device 10 has data programming entered into the data processing apparatus, i.e., the memory 14 or the processor 16 or both (noting that the processor 16 may be integral with a memory device such as the memory 14) which enables the functions of the portable device 10 to be carried out. Data programming may take any desired form, such as software, firmware, and others, in any combination. The data programming is operable by the data processor 16 to receive entry of data by at least one of the operating elements such as the keys 24 and the communications element 18, and to store entered data in the memory 14. The data programming is operable to form a unitary compilation of data which has been entered into the memory 14 such that the data may be selectively retrieved and handled. As employed herein, handling of data will be understood to encompass both display of data on the screen 26 and also transmission of data as a single file to a remote device (not shown). For example, medical personnel such as a doctor may prefer to display the data content on a monitor of a desktop PC rather than on or in addition to the screen 26. The apparatus of the portable device 10 may comprise a hard wired connection such as a universal service bus cable or local wireless connection such as Bluetooth® or both (neither shown). Thus the portable device 10 may either be self-standing, or alternatively may serve as a relay or intermediary, for example, providing and formatting data which is to be displayed on the screen of the desktop PC or other system in the possession of the medical caregiver.

The data programming may be operable to secure data which has been entered into the memory 14 against unauthorized access. This may be implemented for example by requiring entry of a unique identifier such as a password or other code prior to presenting the medical data. The unique identifier may be a biometric key, such as a fingerprint, retinal scan, voiceprint, or other biometric parameter of the patient. The portable device 10 may comprise a suitable reader 30 for reading biometric characteristics of the person associated therewith so as to satisfy the security requirements.

The data programming may be operable to enable selective retrieval of stored data and to present retrieved data in scrolling fashion, wherein the data is visually presented in a single unbroken page as viewed on a screen such as the screen 26. Scrolling signifies the conventional meaning of the term, wherein content of the single page may be progressively displayed without bypassing any of the content by a single manual action using the operating element. The single manual action may comprise depressing of a key such as one of the keys 24, or by depressing a specified portion of the screen such as the screen 26 where the screen is a touchscreen.

Selective retrieval of data signifies that only a portion of the total data entered into the memory 14 may be selected for display or transmission or both. The data programming may be operable to receive data in a first order and to automatically reorganize received data into a second order. An example of this would be establishing pre-established topics and reorganizing received data appropriately into the pre-establish topics. Entered data pertaining to any selected pre-established topic may be summoned for display or transmission or both automatically, without requiring the user to edit retrieved data.

The pre-established topics comprise for example direct medical biographical topics comprising at a minimum prior medical diagnoses, prior surgeries, existing allergies, current medications which are prescribed or are being taken, prior immunizations, family histories, and scheduled and recommended preventive maintenance operations such as immunizations, mammogram, and PAP smear procedures. The pre-established topics may comprise peripheral medical topics comprising at a minimum announcing pre-established power of attorney regarding medical issues, living will arrangements, medical donor information, and emergency contact information. The peripheral medical topic of announcing pre-established power of attorney regarding medical issues may include contact information for any party having pre-established power of attorney. For female patients, the peripheral medical topics may comprise historical menstrual cycle information.

The data programming may be operable to establish a link to data which presents the purposes of a selected pharmaceutical product and side effects of the selected pharmaceutical product. Such data may be stored in the portable device, may be remotely sourced and accessed by an automatically initiated query, or both.

The data programming may be operable to automatically highlight on a screen such as the screen 26 medical events and steps which are scheduled for future occurrence.

The data programming may be operable to provide direct access to emergency assistance by a single manual action, such as by placing a telephone call to a telephone address such as 911. This may be performed in a single manual action such as by pushing one button (such as one of the keys 24) or by depressing a touchscreen at a displayed icon.

The data programming may be operable to automatically enter into the memory updated data relating to general purpose (i.e., not patient specific) medical information. Examples include newly available pharmaceutical products, new conclusions as to purpose of any pharmaceutical product, side effects of existing pharmaceutical products, and changes in medical guidelines as to preventive maintenance. Any of these may be accomplished via passive receipt of updates from data transmitted from a remote source, or by inherent ability of the portable device 10 and its programming to initiate a query of a remote site, or by a combination of these.

The invention may also be thought of as a software application which may be purchased by the general public and loaded into a suitable instrument such as a smart phone, tablet, or like device. The application may comprise that programming necessary to enable a commercial programmable communications device to function as described herein.

The present invention is susceptible to modifications and variations which may be introduced thereto without departing from the inventive concepts. For example, the data programming of a portable device 10 may be operable to maintain separate data relating to more than one person, that is, maintaining medical history of family members or other groups of people, rather than just for one person.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A portable device for compiling, storing, transmitting, and displaying medical data, comprising:
a housing of hand held dimensions and configuration, comprising data processing apparatus further comprising
a memory contained within the housing,
a data processor contained within the housing and disposed in communication with the memory,
an operating element disposed on the housing at the exterior thereof and disposed in communication with the data processor,
a communications element which is disposed in communication with the data processor and is capable of receiving data wirelessly for entry into the memory, transmitting entered data wirelessly, and
a display screen disposed in communication with the data processor and capable of displaying data retrieved from memory; and
data programming entered into the data processing apparatus, operable by the data processor
to receive entry of data by at least one of the operating elements and the communications element,
to form a unitary compilation of data which has been entered into the memory such that the data may be selectively retrieved and handled as a single file,
to present the unitary compilation of data by a conventional personal communications device,
to secure data which has been entered into memory,
to establish a link to data which presents the purposes of a selected pharmaceutical product and side effects of the selected pharmaceutical product.

2. The portable device of claim 1, wherein the operating element is a touchpad screen.

3. The portable device of claim 1, wherein the data programming is operable to receive data in a first order and to automatically reorganize received data into a second order.

4. The portable device of claim 3, wherein the data programming establishes pre-established topics and is operable to reorganize received data appropriately into the pre-establish topics.

5. The portable device of claim 4, wherein the pre-established topics comprise direct medical biographical topics comprising at a minimum prior medical diagnoses, prior surgeries, existing allergies, current medications which are prescribed or are being taken, prior immunizations, family histories, and scheduled and recommended preventive maintenance operations.

6. The portable device of claim 5, wherein the data programming is operable to automatically highlight medical events and steps which are scheduled for future occurrence.

7. The portable device of claim 4, wherein the pre-established topics comprise peripheral medical topics comprising at a minimum announcing pre-established power of attorney regarding medical issues, living will arrangements, medical donor information, and emergency contact information.

8. The portable device of claim 7, wherein the peripheral medical topic of announcing pre-established power of attorney regarding medical issues includes contact information for any party having pre-established power of attorney.

9. The portable device of claim 7, wherein the peripheral medical topics comprise historical menstrual cycle information.

10. The portable device of claim 1, wherein the data programming is operable to enable selective retrieval of stored data and to present retrieved data in scrolling fashion, wherein the data is visually presented in a single page, and content of the single page may be progressively displayed without bypassing any of the content by a single manual action using the operating element.

11. The portable device of claim 1, wherein the data programming is operable to establish a link to data which presents the purposes of a selected pharmaceutical product and side effects of the selected pharmaceutical product.

12. The portable device of claim 1, wherein the data programming is operable to secure access to medical data by requiring entry of a unique identifier prior to presenting the medical data.

13. The portable medical device of claim 12, wherein the unique identifier is a biometric key.

14. The portable medical device of claim 1, wherein the data programming is operable to provide direct access to emergency assistance by a single manual action.

15. The portable medical device of claim 1, wherein the data programming is operable to maintain separate data relating to more than one person.

16. The portable medical device of claim 1, wherein the communications element has ability to conduct general purpose communications over generally available communications channels.

17. The portable medical device of claim 1, wherein the portable medical device is a dedicated medical device lacking ability to conduct general purpose communications over generally available communications channels.

18. A software application for compiling, storing, transmitting, and displaying medical data in a portable device having a data processor, comprising:
data programming in a form which may be loaded into the data processor of the portable device, operable by the data processor
to receive entry of data by at least one of the operating elements and the communications element,
to form a unitary compilation of data which has been entered into the memory such that the data may be selectively retrieved and handled as a single file,
to present the unitary compilation of data by a the portable device,
to secure data which has been entered into memory, and
to automatically enter into the memory updated data relating to general purpose medical information.

19. The software application of claim 18, wherein the data programming is operable to
reorganize received data appropriately into pre-established topics comprising
direct medical biographical topics comprising at a minimum prior medical diagnoses, prior surgeries, existing allergies, current medications which are prescribed or are being taken, prior immunizations, family histories, and scheduled and recommended preventive maintenance operations, and
peripheral medical topics comprising at a minimum announcing pre-established power of attorney regarding medical issues, living will arrangements, medical donor information, and emergency contact information;
automatically highlight medical events and steps which are scheduled for future occurrence;
enable selective retrieval of stored data and to present retrieved data in scrolling fashion, wherein the data is visually presented in a single page, and content of the single page may be progressively displayed without bypassing any of the content by a single manual action using the operating element; and
secure access to medical data by requiring entry of a unique identifier prior to presenting the medical data.

20. The software application of claim 18, wherein the data programming is operable to establish a link to data which at least presents the purposes of a selected pharmaceutical product and side effects of the selected pharmaceutical product.
